(19) United States
(12) Patent Application Publication
(10) Pub. No.: US 2009/0235282 A1
(43) Pub. Date: Sep. 17, 2009

(54) APPLICATION REMOTE CONTROL

(75) Inventors: Erik Meijer, Mercer Island, WA (US); Jeffrey Van Gogh, Redmond, WA (US); John Wesley Dyer, Monroe, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/046,550

(22) Filed: Mar. 12, 2008

(51) Int. Cl. G06F 9/44

(52) U.S. Cl. 719/320

(57) ABSTRACT

Application remote control is affected across execution contexts. In one instance, input can be acquired from controlled applications and employed by other applications. Additionally or alternatively, remote control can be employed to test applications while minimizing unintended changes to applications under test caused by observation.

### CROSS REFERENCE TO RELATED APPLICATIONS

The subject application is related to U.S. patent application Ser. No. 11/752,662, filed May 23, 2007, and entitled NATIVE ACCESS TO FOREIGN CODE ENVIRONMENT and U.S. patent application Ser. No. 11/941,638, filed Nov. 16, 2007, and entitled DEBUGGING MULTI-EXECUTION ENVIRONMENT APPLICATIONS, the entireties of which are incorporated herein by reference.

### BACKGROUND

Application software provides users with specific useful functionality. Computers and other processor-based devices provide hardware that is harnessed by applications to affect such functionality. Accordingly, application software converts computers into specialized machines that perform tasks prescribed by the application. Some applications have tight links to processing machines. Conventional client applications, for instance, are tied to particular computing platforms or hardware architectures. For example, applications designed for platform “X” are not executable on platform “Y” and vice versa. Furthermore, if it is desirous to employ an application on another machine even of the same platform, the application needs to be installed thereon.

With the advent of the Internet and World Wide Web (“Web”), informational access became much less platform dependent. The Internet provides a publically accessible interconnected network of computers. The Web is a collection of documents that are available via the Internet. Web browsers are applications that provide a portal to the Internet and collections of accessible information in the form of websites. While browsers themselves are platform dependent, the information and presentation thereof is platform independent. Accordingly, individuals employing disparate machines can all view the same websites.

The Web is continually evolving into much richer computing environment. For the most part, early versions of the Web enabled users to do little more than retrieve published information. Today's version, referred to by some as “Web 2.0,” provides a much more interactive experience. Among other things, the network itself is now an application platform. Users are thus able to execute and interact with software applications entirely within web browsers replacing actual machine dependency with virtual machine dependency (e.g. Java Virtual Machine (JVM), Common Language Runtime (CLR) . . . ), for instance.

Furthermore, participation is encouraged in the evolving Web. Rather than simply being a receiver of information of a particular form, users are encouraged to contribute to network content and are able to control how information is provided to them. For example, in addition to those provided by companies, individuals author reusable application components or small programs such as gadgets or widgets that provide an interface for data interaction. Users can then select and employ one or more of these components (e.g., stock ticker, weather, Web feeds . . . ) for use on a desktop or within a browser, for instance.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to remote application control. In accordance with an aspect of the disclosure, an application of a first execution context can be controlled by a control application of a second execution context. Control can be affected by simulating human action with respect to a user interface, with direct object model calls or the like, or a combination thereof In general, control can be employed to acquire information from an application. In one particular instance, control can be utilized to test an application to ensure intended results. Furthermore, control can be imposed upon any application including, without limitation, conventional client applications, as well as web applications.

According to another aspect, control code including associated application programming interfaces (APIs) can be written once and utilized to control a plurality of applications across different execution contexts. Mechanisms are provided to facilitate translation or transformation from source, control code executable in one context to target, control code executable in another context. In this manner, control functionality need only be specified once but used repeatedly in various contexts, rather than writing new control code for each context.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an application remote control system in accordance with an aspect of the disclosed subject matter.

FIG. 2 is a block diagram of a representative control component according to a disclosed aspect.

FIG. 3 is a block diagram of a representative control component in accordance with an aspect of the disclosure.

FIG. 4 is a block diagram of a representative initialization component according to an aspect of the disclosed subject matter.

FIG. 5 is a block diagram of an application testing system in accordance with a disclosed aspect.

FIG. 6 is a flow chart diagram of a remote control method in accordance with an aspect of the disclosed subject matter.

FIG. 7 is a flow chart diagram of a remote control communication method according to an aspect of the disclosure.

FIG. 8 is a flow chart diagram a remote control support method according to an aspect of the subject disclosure.

FIG. 9 is a schematic block diagram illustrating a suitable operating environment for aspects of the subject disclosure.

FIG. 10 is a schematic block diagram of a sample-computing environment.

### DETAILED DESCRIPTION

Systems and method pertaining to remote application control are described in detail hereinafter. A control component executable in one execution context can control an application executable in a different execution context. Control can be affected though a user interface, document object model or the like, or a combination thereof. A number of mechanisms are provided to facilitate such interaction including a call translator and a marshalling component, among others. Control can be employed with respect to traditional applications as well as web applications. Furthermore, control can be utilized to interact with applications for instance to acquire particular information or to test an application.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

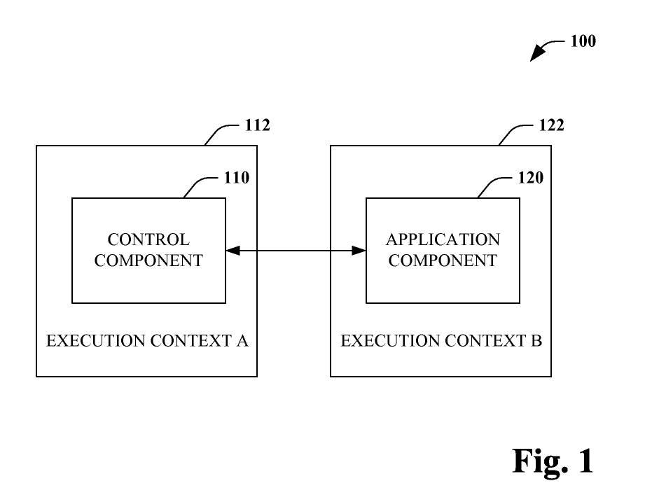

Referring initially to FIG. 1, an application remote control system 100 is illustrated in accordance with an aspect of the claimed subject matter. As shown, the system 100 includes a control component 110 and an application component 120. The application component 120 can be any software application, web application, or component thereof. For example, the application component can be embodied as a spreadsheet application, a macro, or widget, among other things. The control component 110 is a mechanism for controlling the application component 120. In one embodiment, this can be accomplished utilizing an existing plug-in model of the application. Alternatively, if such a plug-in model is not available, this can be accomplished through injection of code within the application component 120 and/or associated execution context 122 so as not to alter the application component 120.

In one instance, the control component 110 can acquire data from the application. By way of example, where the application component 110 is embodied as an email application, the control component 110 can control the email application in a way that enables email to be retrieved. The retrieved email can subsequently be provided to another application or otherwise utilized. It is to be appreciated that the functionality associated with control component 110 goes beyond simple interaction since that implies that the application component 120 has provided some mechanisms or hooks to enable such interaction. That need not be the case. In this instance, the email application does not need to provide an interface to enable the control component 110 to interact with it. As will be described further infra, the control component 110 can utilize higher-level mechanisms (e.g., accessibility/window messaging APIs, native execution environment APIs . . . ) to take control of the application component 120. Accordingly, the control component 110 can interact with almost any application.

In another embodiment, the control component 110 can be employed to test the application component 120. Here, a number of actions are performed followed by one or more tests. These tests can then be executed on a newly developed or updated application component 120, for instance, to verify that it functions as intended. For instance, spreadsheet macros can be tested to ensure that they operate as desired.

Note that control is performed in a remote manner. In particular, the control component 110 and application component 120 are illustrated in different execution contexts, namely execution context A 112 and execution context B 122, respectively. The execution context can include any execution environment, engine, framework or the like that executes/interprets instructions to perform an action. Execution context, can include, but are not limited to virtual machine environments, such as a Java Virtual Machine (JVM), Parrot, or the Common Language Runtime (CLR); native environments, such as native machine instructions; a component object model environment, such as COM and XPCOM; or a scripting environment, such as JavaScript or VBScript. Further, context can differ as a function of execution location (e.g., web browser vs. server-side vs. specific application software).

Often an execution context will have one or more programming languages associated with it (e.g., Java with the Java Virtual Machine, or C# and Visual Basic on the Common Language Runtime) although some programming languages can be compiled/interpreted to result in code that operates in more than one execution context (e.g., C++ to COM and native computer instructions). It is to be appreciated that different execution contexts can refer to dissimilar types of execution environments (e.g., scripting and virtual machine environments) or can include different versions of the same execution environment.

The separation of control component 110 and application component 120 has added benefits in the testing embodiment. By separating the control component 110 and application component 120 across different execution contexts 112 and 122, respectively, it can be ensured that a test will not hang should something go wrong with the application component 120. In other words, the separation provides a deterministic exit even in the event of an application failure. Furthermore, the Heisenberg effect can be minimized or completely avoided where the control component 110 and application component 120 act independently. Otherwise, the act of observing the result of tests could change the application itself by adding additional memory pressure, among other things.

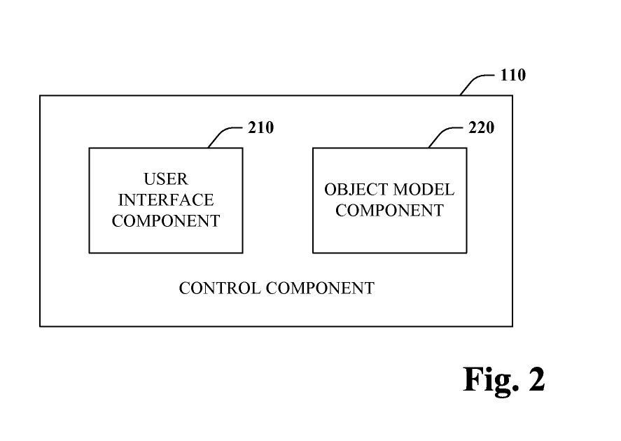

FIG. 2 depicts a representative control component 110 in accordance with an aspect of the claimed subject matter. As shown, the control component 110 includes a user interface component 210 and an object model component 220 as control mechanisms. The user interface component 210 enables the control component 110 to simulate human actions such as cursor movements, mouse clicks, text entry, and the like. In a testing scenario, this is helpful to replicate human behavior to ensure an application will respond appropriately with respect to various human inputs and combinations thereof The object model component 220 enables the control component 110 to access an applications underlying structure or representation. For example, rather than simulating keyboard entries in a text box to set a value, the object model associated with an application, or the like, can be employed to directly set the value via a particular API, for instance. This is a fundamentally more powerful control mechanism, because it is not dependent upon the interface or style thereof. For instance, there may be a style in which a value of interest is invisible, or otherwise inaccessible via the provided interface, but it is still available in the object model. Furthermore, the object model component 220 enables direct testing of application programming interfaces (APIs).

The control component 110 provides a range of control from broad interface control to fine object model control. Conventional, testing frameworks only allow action of the user interface level. Here, control is enabled at high through low levels. Mouse or keyboard actions can be simulated, a specific API can be called or a combination thereof

Sometimes it is good to test what happens when keystrokes are sent, because there might be some timing involved. For instance, if for each keystroke a network call is made, it might make sense in a test to send keystrokes one by one and maybe have some non-determinism where they are sent at different intervals. In other cases, the only thing that may be sought is a value inserted upon a click of a button. In this scenario, it is unnecessary to insert keystrokes one by one. This is not what is being tested. Rather, one may desire to observe how the application reacts upon clicking the button. Just using user interface functionality will not provide that ability. Conversely, if only object model control was enable then UI control would not be available to do other things. Accordingly, control component 110 includes the best of both worlds.

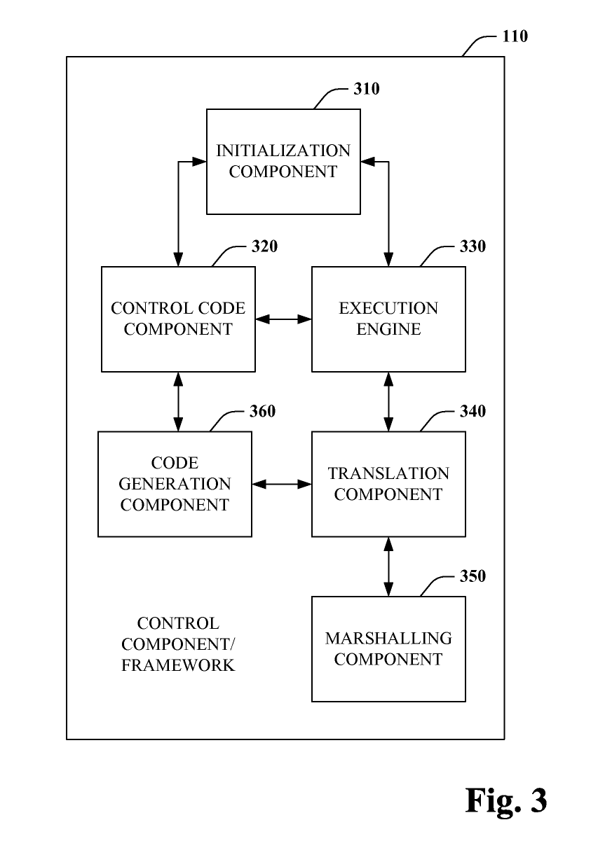

Turning attention to FIG. 3, a representative control component 110 is illustrated in accordance with an aspect of the claimed subject matter. Here, the control component 110 includes various mechanisms to facilitate remote control including initialization component, control code component 320, execution engine 330, translation component 340, marshalling component 350 and code generation component 360. Accordingly, the control component 110 can also be referred to as a control framework or in a testing scenario as a test framework.

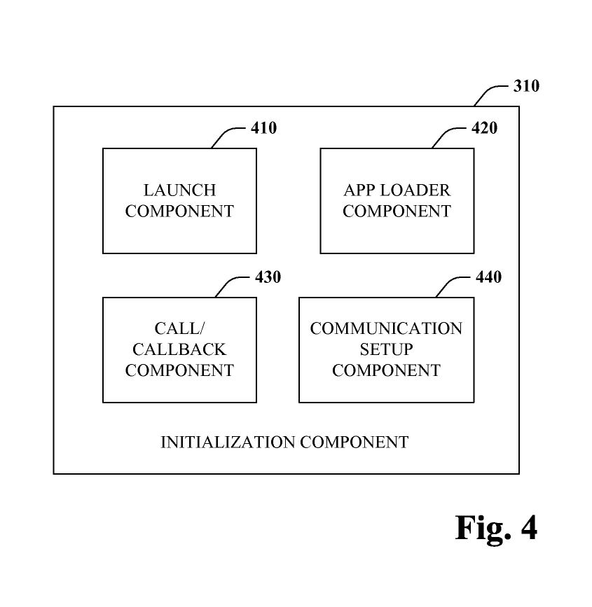

The initialization component 310 provides initialization and/or support functionality needed to commence control of an application and later terminate control. Turning briefly to FIG. 4, a representative initialization component 310 is illustrated that further details particular functionality that can be provided thereby. As depicted, the initialization component 310 includes a launch component 410 that launches or spawns a particular execution context. For example, the component 410 can launch a web browser and/or a particular execution engine (e.g., Java Virtual Machine, flash, Common Language Runtime . . . ). Application loader component 420 loads an application component 120 with respect to the launched execution context. For instance, the application loader component 420 can load a web application or webpage within a web browser. Call/callback component 430 can inject a piece of code within the loaded application component 120 and/or associated execution context to facilitate calling into and returning callbacks from the application component 120. Communication setup component 440 sets up a communication channel between the execution context of a control application and the execution context of the application to be controlled.

Returning to FIG. 3, the control code component 320 specifies control and/or test functionality in a particular language (e.g., C#, C++, VB, Java . . . ). This is beneficial to developers since they can choose to implement control code in a language of their choice and take advantage of development tools including debuggers associated with the language and/or integrated development environment (IDE). Furthermore, the same application programming interfaces (APIs) that are used in program development can be employed to specify control and/or test code. Such control can be user interface based, object model based or a combination thereof. For example, the code can attempt to simulate human interaction with an application (e.g., cursor movement, mouse clicks, keyboard entries . . . ) and/or call directly into an object model or other APIs.

The execution engine 330 (also a component as defined here) executes code afforded by the control code component 320 to affect the intent specified thereby. The execution engine 330 alone or in conjunction with the control code component 320 can communicate with the initialization component 310 to configure and start initialization. For example, the execution engine 330 can initiate initialization by passing parameters indicative of an application and execution context.

The translation component 340 aids execution with respect to a target execution context by translating or facilitating translation of calls specified by the control code to application calls automatically. Accordingly, a single control application can be specified that can control any application regardless of environment. For example, a lone controlling application can operate with respect different web browsers without requiring changes to the controlling application. In a simple embodiment, the control code can include attributes and additional code identifying a specific implementation for various scenarios. Once contextual information is available pertaining to an application and/or execution thereof, the relevant code can be identified, generated based thereon, or otherwise employed in a translation. For example, each control call can include a code for specific browsers such that once a browser is identified the translation component can simply translate, select, and/or generate appropriate code as a function of the associated code. In one implementation, the translation component 340 can act as a foreign function interface, for example as described in the incorporated application entitled NATIVE ACCESS TO FOREIGN CODE ENVIRONMENT.

The marshalling component 350 is a mechanism that enables cross-execution or environment communication between a control execution context or environment 114 (FIG. 1) and an application execution context or environment 122 (FIG. 1). For example, the marshalling component 350 can maintain caches between the two environments to ensure object identity and initiate or perform serialization. Further yet, it is to be noted that since data types between the environments can be different, the marshalling component 350 can cast parameters to their correct data type when exchanging between execution environments. In this manner, the marshalling component 350 affords an execution environment bridge that mediates specific communications such as events, messages, or API calls between a controller and a controlee. In one embodiment, the translation component 340 can simply identify how calls are to be translated and the marshalling component 350 can perform the actual translation. See, for example, the related applications incorporated herein by reference.

The code generation component 360 facilitates generation of control code or application programming interfaces (APIs) employable by the code. More specifically, the code generation component 360 is a mechanism that automatically generates code in a source language that facilitates translation into a target language. By way of example, a developer can simply specify a signature and optionally a specific attribute and perhaps related code and the code generation component 360 can generate the implementation. Moreover, the generated code can be produced in a manner that facilitates translation to a target language via the translation component 340 and/or marshalling component 350. For example, the generated code can include a specific attribute such as “IMPORT” with target language code that implements the source language code to which it is attached. This can be accomplished as detailed further in the incorporated application entitled NATIVE ACCESS TO FOREIGN CODE ENVIRONMENT.

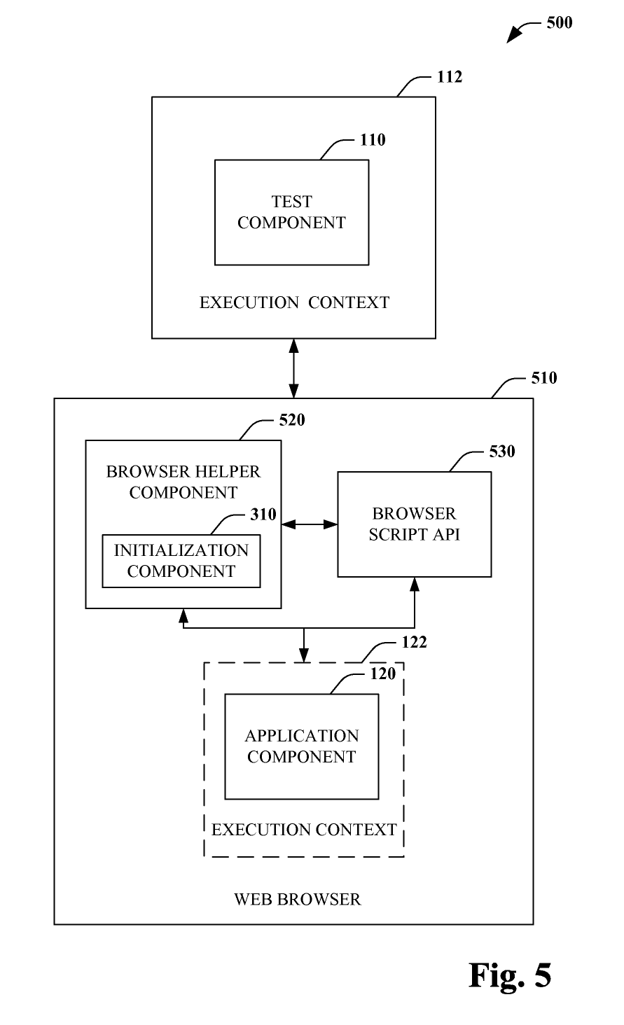

Referring to FIG. 5, an application testing system 500 is illustrated in accordance with a specific embodiment of the claimed subject matter. The system 500 includes a specific embodiment of the control component 110 for testing, namely test component 1 10. The test component 110 is executable inside execution context or environment 112. The test component 110 seeks to test application component 120. In this embodiment, the application component 120 is a web application executable within a browser 510 and optional more specific execution context 122 including but not limited to a virtual machine.

The web browser 510 includes a browser helper component 520 such as a testing plug-in. The test component 110 and/or associated component functionality can ensure that the web browser 510 includes or loads the browser helper component 520. This component 520 can include the initialization component 310 or described functionality that can launch browser 510 and/or execution context 122, load the application component 120 under test therein, and open a communication channel between the test component 110 and the application component 120 via the execution context 1 12, web browser 510, and execution context 122. It is also to be noted that the browser helper component 520 can inject code into the application component 120, such as that provided by a supported browser scripting API 530, to facilitate making calls and callbacks to and from the application component 120 through the browser helper component 520, for example.

Once initialization is performed, the test component can execute test code within the execution context. This code can then be translated or transformed and transmitted to the application component 120 for execution. In one instance, calls can be made to browser scripting code embodied by the browser scripting API. Information can be exchanged in both directions between the test and application components 110 and 120, respectively. When the test terminates, the browser helper component can facilitate reversing the initialization process by closing the application component 120, execution context 122, and browser 5 10, among other things.

To facilitate further clarity with respect to system 500 as well as other disclosed aspects, the following detailed portion is provided. It is to be appreciated that these details are provided solely to aid clarity and understanding with respect to aspects of the claimed subject matter. They are not meant to limit the spirit or scope of the claims in any manner.

The browser helper component or plug-in 520 can include code that facilitates testing within the browser 5 10. The plug-in 520 can connect back to test component 110 and register an object that will be responsible for marshalling generated JavaScript to the browser. It can also inject a piece of JavaScript into the loaded web application 120 that helps the plug-in 520 perform JavaScript calls and callbacks. After initialization, testing can commence. The test can use APIs written in the same language as the test itself and they can be transformed or utilized to generate correct JavaScript code for the browser 510. The APIs can be similar to others used to test web application with the exception that they can specify a particular browser to use as follows in the exemplary code snippet:

```
  public sealed class BrowserDriver : IDisposable
  {
    public BrowserDriver(BrowserType type, string url);
    public BrowserDriver(BrowserType type, string url, int
timeOutInSeconds);
    public Keyboard Keyboard { get; }
    public BrowserType Type { get; }
    public void Dispose( );
    public static BrowserType[ ] AvailableBrowsers { get; }
  }
  public enum BrowserType
  {
    InternetExplorer = 0,
    Firefox = 1,
  }
```

This API also implements “IDisposable” which is a pattern where a developer writes his/her test employing a “using” statement and the moment the test completes, the test code will be automatically cleaned up and make sure the browser is closed and the communication channel is closed, among other things.

The following is sample code to test a web page “http://www.example.com”:

```
foreach (var browser in BrowserDriver.AvailableBrowsers)
{
  using (var bd = new BrowserDriver(browser,
                    @“http://www.example.com”))
  {
    var q = Browser.Document.GetById<Input>(“q”);
    q.PerformFocus( );
    q.Value = “Sarpedon”;
    var btnG = Browser.Document.GetById(“go”);
    q.PerformClick( );
    HtmlFutures.AssertNavigationTo(“http://www.example.com/
    result.aspx”).Block( );
      Assert.IsTrue(Browser.Document.Body.InnerHtml.Contains(
                    “Sarpedon”));
      }
}
```

The “foreach” loop finds all available browsers a machine executing the test. The “using” statement indicates that for each browser the specified test should be run on the web page “example.com” and the browser closed thereafter. In the test, the HTML input element from the webpage identified as “q” is retrieved and made the active element, the value of “q” is then set to “Sarpedon,” the associated “GO” button is identified and a click is simulated thereon, and the test waits for a result page to be loaded. Subsequently, the result page is checked to determine if it include the intended result. It should be appreciated that element interaction could have been on a user interface level rather than utilizing direct object model calls and that events could be utilized in place of sleep/busy loops.

It is to be noted that a tester does not notice any difference between programming any other application in his/her favorite programming language even thought the test uses JavaScript and different browsers with APIs exposed through different frameworks.

APIs can also be tested as part of the web page. Conventional test frameworks lack direct support for such scenarios since they usually support purely UI testing and do not understand JavaScript APIs used on a webpage. Hence, testing such APIs cannot be done in a high-level language in which the test is written. For example, when testing a mapping application embedded in the webpage, the test can call into the API provided by the mapping application. To do so, the test code defines an API in the source language and employs the import mechanism described by NATIVE ACCESS TO FOREIGN CODE ENVIRONMENT incorporated herein by reference:

```
[Import(ScriptMemberNameCasing = Casing.Pascal,
PassInstanceAsArgument = false)]
  public class Map
  {
    private static int s_counter;
    [Import(“function(id) { return new VEMap(id); }”)]
    public extern Map(string id);
    public extern LatLong GetCenter( );
  }
```

Now the test can access information about the map in the application (by fetching a value of type Map from the page) without having to write a lot of glue to call out to the JavaScript in the page.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the code generation component 360 can employ such mechanism to determine or infer test code to be generated from limited information.

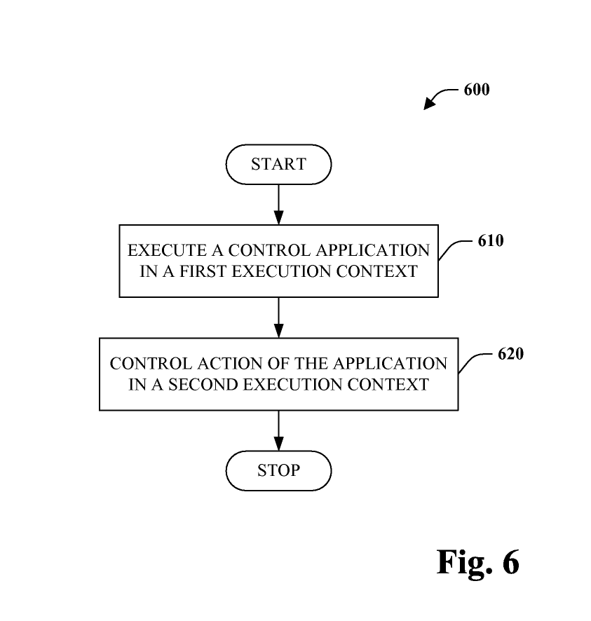

In view of the exemplary systems described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 6, a remote control method 600 is illustrated in accordance with an aspect of the claimed subject matter. At reference numeral 610, a control application is executed within a first execution context. At numeral 620, the action of an application in a second execution context is controlled by the control application. In this manner, control applications can be generated for and executed within a first execution context and used to control applications in different context. Control can be embodied as user interface simulations, direct object model level calls or a combination thereof. Control can be employed to retrieve information from the application for subsequent use or for testing the application among other things. For example, a client email application can be controlled to retrieve email and provide them to another application. Alternatively, a web application can be tested to ensure proper operation. In the case of testing, the separation of test and application under test allows the application under test to fail without causing the test to hang enables testing without disturbing the application under test, among other things.

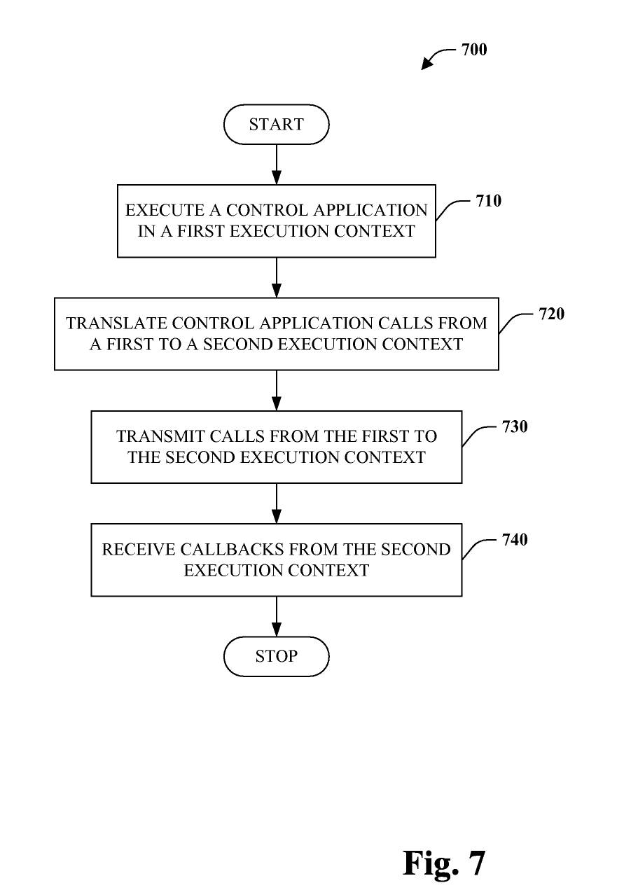

FIG. 7 depicts a remote control communication method 700 according to an aspect of the disclosure. At reference numeral 700, a control application is executed in a first execution context. For example, a high-level object oriented language control program can be executed with a multi-language execution framework. At numeral 720, control application calls are translated from a first to a second execution context. In on instance this can be done automatically as a function of an attribute on a control application construct identifying an alternate implementation. At reference 730, the translated calls are transmitted to the second execution context for execution. At reference numeral, 740 callbacks can be received from the second execution context in a first execution context format. Accordingly, a test can be developed from and executed within a single execution context and utilized to control any other application associated with a different execution context.

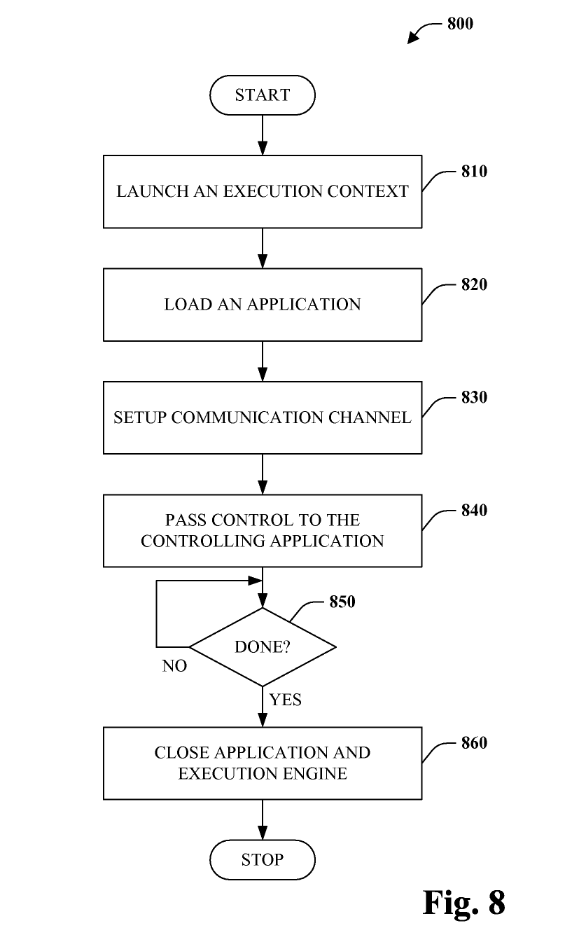

Referring to FIG. 8, a flow chart diagram illustrates a control support method 800 in accordance with an aspect of the claimed subject matter. In one embodiment, the method 800 can be executed by a browser helper or plug-in. However, the claimed subject matter is not limited thereto. At reference numeral 810, an execution context is launched. This can correspond to initiating one or more execution engines, among other things. For example, a web browser is spawned and a virtual machine initiated. At numeral 820, a target application is loaded within the launched execution context. For instance, a web page is loaded within a web browser. At reference 830, a communication channel is setup or otherwise established between a control application in a first execution context and a target application in a second execution context. At reference numeral 840, control is passed to the controlling application. At numeral 850, a determination is made as to whether the controlling application is finished or done. If no, the method continues to loop until it is done. When the control application is fished, the controlled application, execution engine and communication channel are all closed at 860 and the method terminates.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

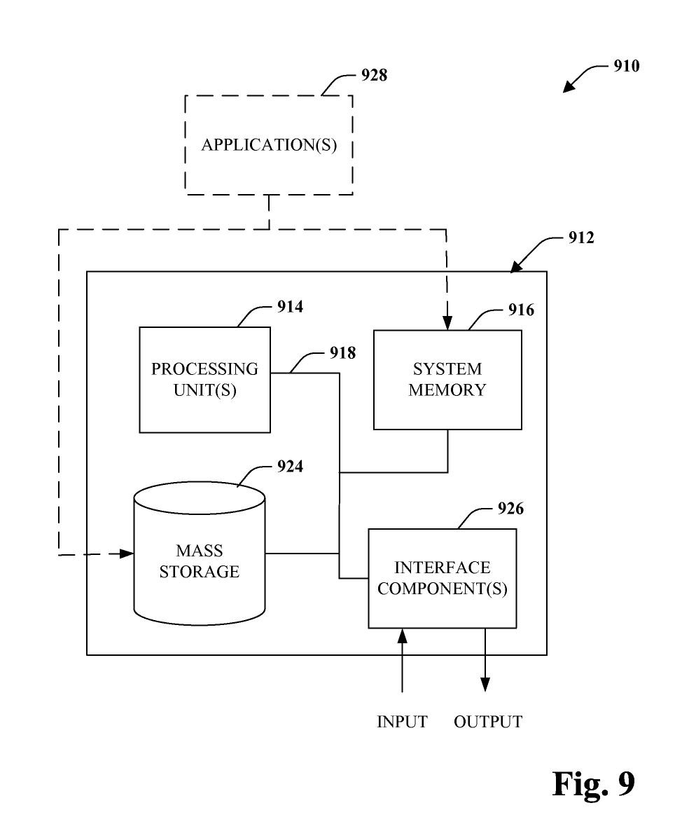

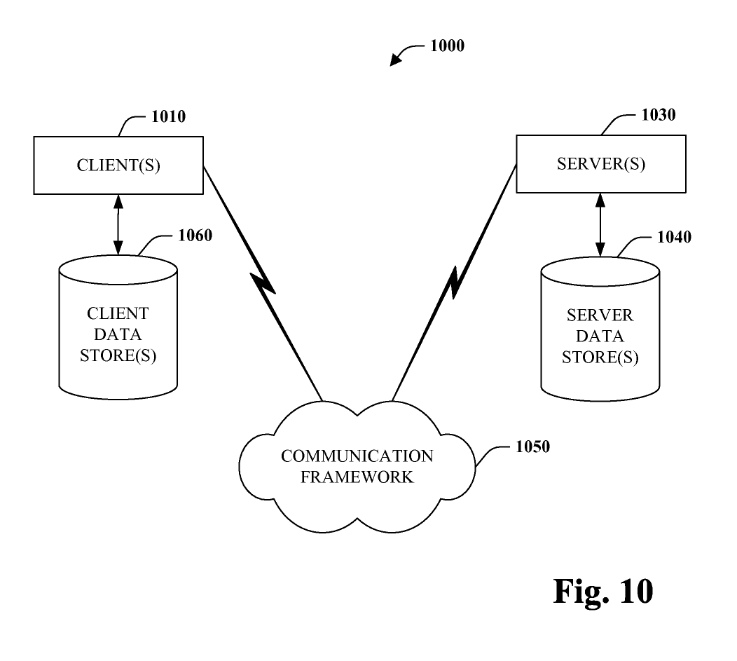

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 910 for implementing various aspects disclosed herein includes a computer 912 (e.g., desktop, laptop, server, hand held, programmable consumer or industrial electronics . . . ). The computer 912 includes a processing unit 914, a system memory 916, and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory, or memory stick. In addition, mass storage 924 can include storage media separately or in combination with other storage media.

FIG. 9 provides software application(s) 928 that act as an intermediary between users and/or other computers and the basic computer resources described in suitable operating environment 910. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

Client/server interactions can be utilized with respect with respect to various aspects of the claimed subject matter. By way of example and not limitation, a test can execute on a client 1010 control an application resident on another client 1010 or a server 1030 across the communication framework 1050.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A application remote control system, comprising
an application component executable in a first execution context; and
a control component executable in a second execution context that controls actions of the application component with a combination of user interface and object model level calls.

2. The system of claim 1, the control component performs tests on the application component.

3. The system of claim 1, the second execution context is a general-purpose execution environment.

4. The system of claim 3, the first execution context is a web browser.

5. The system of claim 1, the first execution context is a web browser based execution engine.

6. The system of claim 1, further comprising a component that translates control component calls to application component calls automatically.

7. The system of claim 6, further comprising a component that generates at least a portion of the control component in a manner that enables translation.

8. The system of claim 1, further comprising a component that marshals values between the execution contexts.

9. The system of claim 1, the control component employs code injection to facilitate control without altering the application component.

10. A method of a controlling an application remotely, comprising:
executing a control application in a first execution context;
translating control application calls to target application calls; and
transmitting the call to a target application in a second execution context.

11. The method of claim 10, further comprising receiving a call back from the target application.

12. The method of claim 10, further comprising executing calls to a user interface and/or underlying object model.

13. The method of claim 10, further comprising launching a target application execution engine.

14. The method of claim 13, further comprising loading the target application.

15. The method of claim 14, further comprising establishing a communication channel between the first execution context and the second execution context.

16. The method of claim 15, further comprising injecting code within the target application without modifying the application's source code to facilitate making calls and receiving callbacks.

17. An application remote control system, comprising:
means for controlling an application; and
means for translating calls from a controlling application in a first execution context to calls of a controlled application in a second execution context.

18. The system of claim 17, further comprising a means for controlling user interface input to the application of a different execution context.

19. The system of claim 18, further comprising a means for controlling input through object model interaction.

20. The system of claim 19, the means (110) for controlling the application tests the application.
